(19) United States
(12) Patent Application Publication
(10) Pub. No.: US 2001/0054176 A1
(43) Pub. Date: Dec. 20, 2001

(54) Run-time personalization architecture

(76) Inventors: Harrick M. Vin, Austin, TX (US); Syed M. Husain, Austin, TX (US)

Correspondence Address: WILSON SONSINI GOODRICH & ROSATI, 650 PAGE MILL ROAD, PALO ALTO, CA, 943041050

(21) Appl. No.: 09/780,945

(22) Filed: Feb. 8, 2001

Related U.S. Application Data
(60) Provisional application No. 60/181,677, filed on Feb. 11, 2000.

(51) Int. Cl. G06F 9/45

(52) U.S. Cl. 717/5

(57) ABSTRACT

Computer executable logic is provided which comprises logic that extracts information and/or application front ends from a network or local resource; logic that manipulates and/or enhances extracted content to new looks and feels or with modified functionality; and logic that provides a mechanism by which complex transformations and applications can be constructed by composing any number of manipulation and extraction operations at run-time.

### REFERENCE TO CO-PENDING APPLICATIONS

This application is a continuation-in-part of U.S. Provisional Application Serial No. 60/181,677, filed Feb. 11, 2000, which is incorporated herein by reference in its entirety.

### BACKGROUND OF THE INVENTION

1. Field of the Invention

The present invention relates to methods and software for generating personalized content.

2. Description of Related Art

Today's personal portal providers (MSN, My Netscape, My Excite, My Lycos, My Yahoo, etc.) define the categories of information content (e.g. news, weather, stock quotes, search, etc.) and the sources of information (e.g. New York Times, CNN, etc.) available to users at the time of deploying the service. Users, while personalizing their sites, are merely allowed to select from this pre-defined set of information categories and sources, determine the order of their presentation and select an appropriate layout for the information (e.g. customize color, fonts, and number of columns, etc.). Today's “My” portals are limited in their ability to meet the user's personalization needs.

For example, they support personalization through scripts created at the time of deploying the service. Hence, inherently, they are incapable of supporting arbitrary levels of user-driven personalization. They utilize a different, monolithic program to access and customize content from each information source. This approach limits the customization features to those predicted a priori and requires considerable amount of programming effort for the addition of information sources and personalization features. They also support a small number of information sources. They do no tap into the information published at arbitrary personal, corporate, commerce and hobbyist sites on the web.

### SUMMARY OF THE INVENTION

Computer executable logic is provided which comprises logic that extracts information and/or application front ends from a network or local resource; logic that manipulates and/or enhances extracted content to new looks and feels or with modified functionality; and logic that provides a mechanism by which complex transformations and applications can be constructed by composing any number of manipulation and extraction operations at run-time.

A computer executable method is also provided which extracts information and/or application front ends from a network or local resource; manipulates and/or enhances extracted content to new looks and feels or with modified functionality; and provides a mechanism by which complex transformations and applications can be constructed by composing any number of manipulation and extraction operations at run-time.

### BRIEF DESCRIPTION OF THE DRAWINGS

FIG. 1 depicts the 2-step personalization content generation process.

### DETAILED DESCRIPTION OF THE INVENTION

The present invention relates to a novel architecture for implementing Personal Pages. The architecture allows users to completely personalize the layout, structure, and content of their Personal Pages. Each user defines what is important to her, how the information is grouped together or categorized, where the information comes from, and how the information is manipulated, integrated and presented in the user's Personal Page. This allows each user to create a personal web experience that is aligned with the way she thinks and organizes her information; the personal experience is not constrained by the choices made by the portal provider at the time of deploying the service.

When designing an architecture for realizing the proposed service, the following issues should be considered. Users should be allowed to substantially if not completely customize the layout, structure and content of their Personal Portal. It is not possible to predict the set of information sources that a user may be interested in or how the user may want to view the content extracted from the these sources. Hence, the architectures that personalize content by executing a script (created at the time of deploying the service) that merely selects information from a pre-defined set of sources are inherently inadequate. Furthermore, since each user profile is likely to be completely unique, pre-defined structures for maintaining those profiles are inadequate.

To address this issue, the architecture of the present invention enables user profiles to contain information pertaining to the layout, the structure, and the content of a user's Personal Page. Such a profile will contain both data and data-action bindings for constructing a user's Personal Page.

The task of adding new information sources and methods for transforming and presenting data extracted from the sources should be simple. According to the present invention, the addition of new functionality in the system is simplified by minimizing the amount of coding required to add the functionality. To achieve this, the architecture enables reuse of existing code, and facilitates the development of complex functions through composition of basic building blocks.

The architecture should simplify the promotion of new functionality. According to the present invention, once new functionality is added, promoting it to an individual user's Personal Page is straightforward and does not require system downtime or impose large overhead.

The architecture should be scalable and provide high performance. According to the present invention, the proposed service generates content for each user's Personal Page dynamically. To successfully deploy such a service, the architecture must be scalable. Additionally, since most users will not understand the complexity of a dynamic offering, they will demand performance of at least equal to that provided by today's static portals.

The architecture should also support event notification and other anytime, anywhere services. Event notification is central to personalized information delivery in the future. Unfortunately, it is not possible to predict the types of events of interest or the methods for notification desired by users. Hence, the architecture should allow users to define arbitrary events of interest and methods for notification, including the type of device they wish to use (e.g., two-way pager, cellular phone, and fax machine).

The run-time personalization technology of the present invention allows a user to completely customize the layout, structure and content of his/her Personal Page.

User's can select a layout for their Personal Page either from a pre-defined set of templates or by creating a new template.

Users can define the structure of their Personal Page by specifying their own grouping and categorization of information content. This structure is captured as a hierarchy. The server allows users to create arbitrarily structured pages. Each page contains a collection of categories. A category represents a container for personalized information extracted from a single information source or a group of information sources.

An information source refers to any HTTP accessible source of information (e.g., CNN, New York Times (NYT), Washington Post (WP), Wall Street Journal, a search engine, etc.). An information group contains sources with common attributes (e.g. financial information group may contain Wall Street Journal and Financial Times).

The personalized content for each category is produced by a chained execution of Extractors and Manipulators. An Extractor is a program that extracts relevant information from an HTTP accessible information source. In the extreme case, there is a one-to-one correspondence between information sources and Extractors. An Extractor can be used for multiple information sources if the sources publish information in a common format (e.g. ICE, WIDL, Wavo's NewsPak, etc.). A Manipulator is a program that transforms data to meet the personalization requirements of users. A custom links embedder, a text formatter, and an image transcoder are examples of Manipulators. Extractors and Manipulators are independent programs (or objects) with well-defined methods.

The binding between a user-defined Personal Page and the sequence of Extractors and Manipulators that produce content for its categories is specified in a Personalizer. A Personalizer is a program written in Kscript—Kurion's proprietary scripting language. Kscript programs are interpreted at the server; the interpretation process produces Action Lists that define the sequences for executing Extractors and Manipulators that produce the personalized content of categories. The server maintains one Personalizer for each Personal Page defined by a user.

The layout, structure, and corresponding Personalizers are automatically generated when a user creates a Personal Page at the Kurion server. The user can modify these initial settings at any time.

Having introduced the basic terminology, the process of delivering personalized content from the server will now be discussed.

1. Personalized Content Generation

Generating personalized content in response to a user's request is a 2-step process. In the first step, the Kurion server generates Action Lists, one for each category. In the second step, the server executes these Action Lists and produces the personalized content.

A. Action List Generation

The task of generating Action Lists is divided into two phases. In the first phase, the Kurion server determines the set of Personalizers to apply to produce the content of the selected Personal Page. In the second phase, the server processes Kscript commands from the selected Personalizers to device the Action Lists.

1. The server uses a rules-based engine to determine the set of Personalizers to apply to produce the content of the selected Personal Page. The server selects the set of Personalizers based on parameters such as (1) the userID and the selected Personal Page, (2) the group that the user may belong to, (3) system-defined set of global Personalizers, (4) device-specific Personalizers, and (5) IP-address-specific Personalizers. The selected Personalizers are concatenated together and the resulting Personalizer is sent to the Kscript Interpreter.

2. The Kscript Interpreter processes the commands from the Personalizer and produces Action Lists for each category. Each Action list contains a chained execution sequence of Extractors and Manipulators that produce the personalized content for each user-defined category.

B. Personalized Content Generation

Once all the commands contained in the selected set of Personalizers are processed, the Kscript Interpreter forwards all the Action Lists for each category to the execution engine. The execution engine coordinates the chained execution of Extractors and Manipulators contained in the Action Lists to produce the personalized content for each category.

Note that Extractors and Manipulators are objects with well-defined methods. The server maintains a repository of these objects. The execution engine provides an environment for chaining together the execution of these objects at run-time. This is fundamentally required for any user-driven personalization offering.

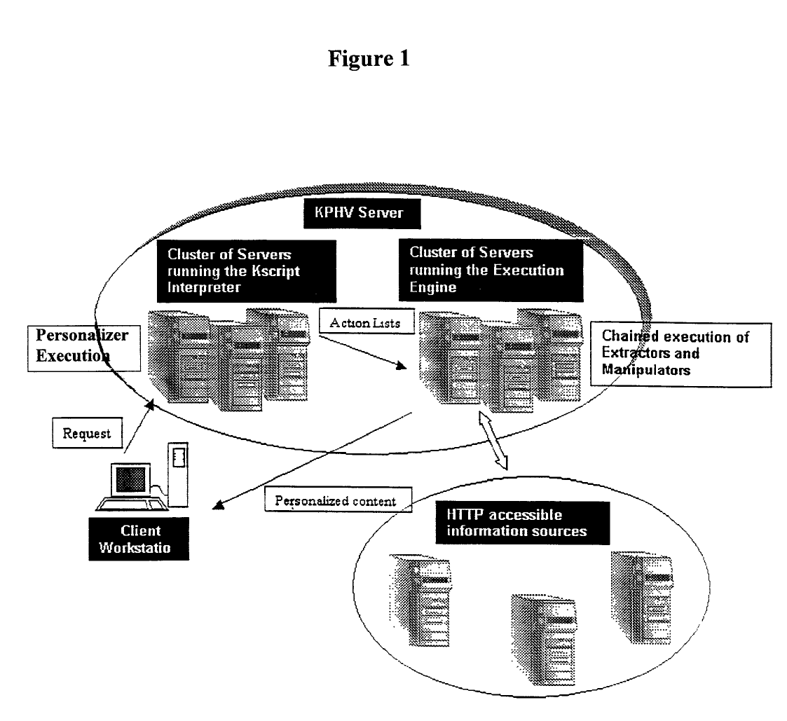

FIG. 1 depicts the 2-step personalization content generation process.

C. Kscript Language

Kscript is a proprietary scripting language. It is an interpreted language. Personalizers are Kscript programs. A Personalizer operates on documents: each document is represented as a hierarchy (or a tree); this hierarchy captures the structure of a user's Personal Page. Each user-defined category is a node in this information hierarchy.

Kscript supports operators to manipulate the structure of a user's hierarchy as well as constructs to associate actions with channels and categories. The operators include (1) insert a node in the hierarchy, (2) delete a node, (3) associate a URL with a node, (4) define attributes for nodes in the hierarchy, (5) assign a value to an attribute at a node, and (6) associate Extractors and Manipulators to the nodes.

The binding of these operators and constructs with specific a category (or node) defined in the user's Personal Page is specified through a Boolean predicate. The syntax for a typical Kscript statement is:

At (predicate): action parameter_list

where action refers to one of the Kscript supported operators. A predicate may be satisfied at several nodes; in such a case, the associated action is performed for all of the selected nodes.

D. Interpreting Kscript Programs

The Kscript interpreter maintains the hierarchical document structure in a relational database. The Kscript interpreter begins the execution of the selected Personalizers by initializing a temporary table in a relational database. The structure of the hierarchy (i.e. the parent-child relationships) is maintained using explicit pointers in the relational table. The default schema for this table is:

<nodeID, nodeName, URL, Parent, leftChild, leftSibling, rightsibling>

Operators for inserting or deleting a node from the hierarchy result in the addition or deletion of an entry from the relational table. On encountering a statement that defines a new attribute, the interpreter extends the default schema. Similarly, on encountering an assignment statement, the interpreter initializes the value of a user-defined attribute. Finally, on processing a statement that associated an Extractor/Manipulator to a node, the interpreter appropriately updates the URL attribute of the selected node.

The interpreter uses the predicate specified in each command to select the node(s) (or the entry in the relational table) on which the specified action is performed.

When the interpreter completes the processing of the Personalizer, the URL field of each node in the hierarchy contains the Action List (containing a sequence for executing Extractors and Manipulators) for producing personalized content for the category.

Note that the schema does not contain any content; it only contains attributes associated with the node and a pointer to its content.

E. Execution Engine for Extractors and Manipulators

The Action Lists produced by the Kscript interpreter are sent to the Execution Engine for the generation of personalized content. The execution engine coordinates the chained execution of Extractors and Manipulators contained in the Action Lists to produce the personalized content for each category.

Extractors and Manipulators are objects with well-defined methods. The server maintains a repository of these objects. The execution engine provides an environment for chaining together the execution of these objects at run-time.

The personalized content produced as a result of executing the Action Lists is then sent back to the client's browser.

F. Benefits and Features of Architecture of the Present Invention

The architecture of the present invention is unique and has the following benefits and features.

The architecture supports run-time generation of Action Lists (or personalization scripts). This enables rapid deployment of new functionality. Furthermore, users are not constrained by the personalization scripts created at the time of deploying the service.

The Kscript language and the concept of run-time generation of Action Lists are unique to our architecture. These features enable the development and rapid deployment of user-driven personalization services that go well beyond the current state-of-the-art.

The architecture is extensible. Extractors and Manipulators are each independent programs (or objects) with well-defined methods. The execution engine in our architecture chains together the execution of objects at run-time to derive complex customization features. The objects themselves, however, are unaware of the existence of each other, which means they are equally unaware of how they are composed together to generate personalized content. This simplifies and accelerates the design and implementation of Extractors and Manipulators.

Addition of Extractors increases the set of supported information, while the addition of Manipulators increases the types of manipulations that can be performed on the data. Together, this results in an exponential increase in functionality.

The architecture also allows the functionality of the service to be dynamically extended without disrupting existing service; no re-compilation of the server is required.

The architecture is scalable. The unique feature of this architecture is the granularity at which parallelism is exploited. Unlike conventional servers that exploit parallelism across user requests, our architecture partitions the task of servicing a single user request into a large number of smaller computational tasks that can be executed concurrently. By exploiting this fine granularity of parallelism, the architecture enables better utilization of computational resources, and thereby scales with increases in the size of the server cluster.

It is believed that the design and operation of the run-time personalization architecture addresses the challenges in meeting the personalization needs of the future.

While the present invention is disclosed as detailed above, it is to be understood that the disclosure is intended in an illustrative rather than limiting sense, as it is contemplated that modifications will readily occur to those skilled in the art, which modifications will be within the spirit of the invention and the scope of the appended claims.

We claim:

1. A computer executable logic comprising:
logic which extracts information and/or application front ends from a network or local resource;
logic which manipulates and/or enhances extracted content to new looks and feels or with modified functionality; and
logic which provides a mechanism by which complex transformations and applications can be constructed by composing any number of manipulation and extraction operations at run-time.
